(19) United States
(12) Patent Application Publication
(10) Pub. No.: US 2003/0233655 A1
(43) Pub. Date: Dec. 18, 2003

(54) Method and apparatus for an adaptive stereotypical profile for recommending items representing a user's interests

(75) Inventors: Srinivas Gutta, Yorktown Heights, NY (US); Kaushal Kurapati, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/174,450

(22) Filed: Jun. 18, 2002

(51) Int. Cl. H04N 5/445; G06F 3/00; G06F 13/00

(52) U.S. Cl. 725/46

(57) ABSTRACT

A method and apparatus are disclosed for recommending items of interest to a user, such as television program recommendations. According to the principals of the invention, initial recommendations, which may be generated before a viewing history or purchase history of the user is available, are adapted or transformed to better capture a users viewing behavior using a feedback process. In particular, stereotypes are generated, which are used to build a stereotypical profiles. Stereotypical profiles are then generated that reflect the typical patterns of items selected by representative viewers. Recommendations are computed against a ground truth data using the stereotypical profiles, wherein distances are computed between each show in a so called ground truth data with the centroid of each stereotype in the stereotypical profile. If there is disagreement between what is computed recommendation and the original ground truth data, then additional feedback is solicited from a user, which is used to create a meta-profile. A meta-profile consists of the set of all weights the user has provided for the shows that he/she wants the shows to be recommended or discarded (e.g. positive/negative reinforcement). Lastly, the recommendation is recomputed using the meta-profile against the stereotypical profile.

### FIELD OF THE INVENTION

The present invention relates to methods and apparatus for recommending items of interest, such as television programming, and more particularly, to techniques for recommending programs and other items of interest.

### BACKGROUND OF THE INVENTION

As the number of channels available to television viewers has increased, along with the diversity of the programming content available on such channels, it has become increasingly challenging for television viewers to identify television programs of interest. Electronic program guides (EPGs) identify available television programs, for example, by title, time, date and channel, and facilitate the identification of programs of interest by permitting the available television programs to be searched or sorted in accordance with personalized preferences.

A number of recommendation tools have been proposed or suggested for recommending television programming and other items of interest. Television program recommendation tools, for example, apply viewer preferences to an EPG to obtain a set of recommended programs that may be of interest to a particular viewer. Generally, television program recommendation tools obtain the viewer preferences using implicit or explicit techniques, or using some combination of the foregoing. Implicit television program recommendation tools generate television program recommendations based on information derived from the viewing history of the viewer, in a non-obtrusive manner. Explicit television program recommendation tools, on the other hand, explicitly question viewers about their preferences for program attributes, such as title, genre, actors, channel and date/time, to derive viewer profiles and generate recommendations.

While currently available recommendation tools assist users in identifying items of interest, they suffer from a number of limitations, which, if overcome, could greatly improve the convenience and performance of such recommendation tools. For example, to be comprehensive, explicit recommendation tools are very tedious to initialize, requiring each new user to respond to a very detailed survey specifying their preferences at a coarse level of granularity. While implicit television program recommendation tools derive a profile unobtrusively by observing viewing behaviors, they require a long time to become accurate. In addition, such implicit television program recommendation tools require at least a minimal amount of viewing history to begin making any recommendations. Thus, such implicit television program recommendation tools are unable to make any recommendations when the recommendation tool is first obtained.

A need therefore exists for a method and apparatus that can recommend items, such as television programs, unobtrusively before a sufficient personalized viewing history is available. In addition, a need exists for a method and apparatus for accurately capturing the users viewing behavior.

### SUMMARY OF THE INVENTION

Generally, a method and apparatus are disclosed for recommending items of interest to a user, such as television program recommendations. According to the principals of the invention, initial recommendations, which are generated before a viewing history or purchase history of the user is available, are adapted or transformed to better capture a users viewing behavior using a feedback process.

Initially, stereotypes are generated, for example from view histories of a particular viewing area, which are used to build a stereotypical profiles. Stereotypical profiles are then generated that reflect the typical patterns of items selected by representative viewers. Recommendations are computed against a ground truth data using the stereotypical profile using the stereotypical profiles. The distance is computed between each show in the ground truth data with the centroid of each stereotype in the stereotypical profile. If there is disagreement between what is computed recommendation and the original ground truth data, then additional feedback is solicited from a user, which is used to create a meta-profile. A meta-profile consists of the set of all weights the user has provided for the shows that he/she wants the shows to be recommended or discarded (e.g. positive/negative reinforcement). Lastly, the recommendation is recomputed using the meta-profile against the stereotypical profile.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram of a television program recommender in accordance with the present invention; and

FIG. 2 is a flow chart describing the adaptive stereotype profile process of FIG. 1 embodying principles of the present invention.

### DETAILED DESCRIPTION

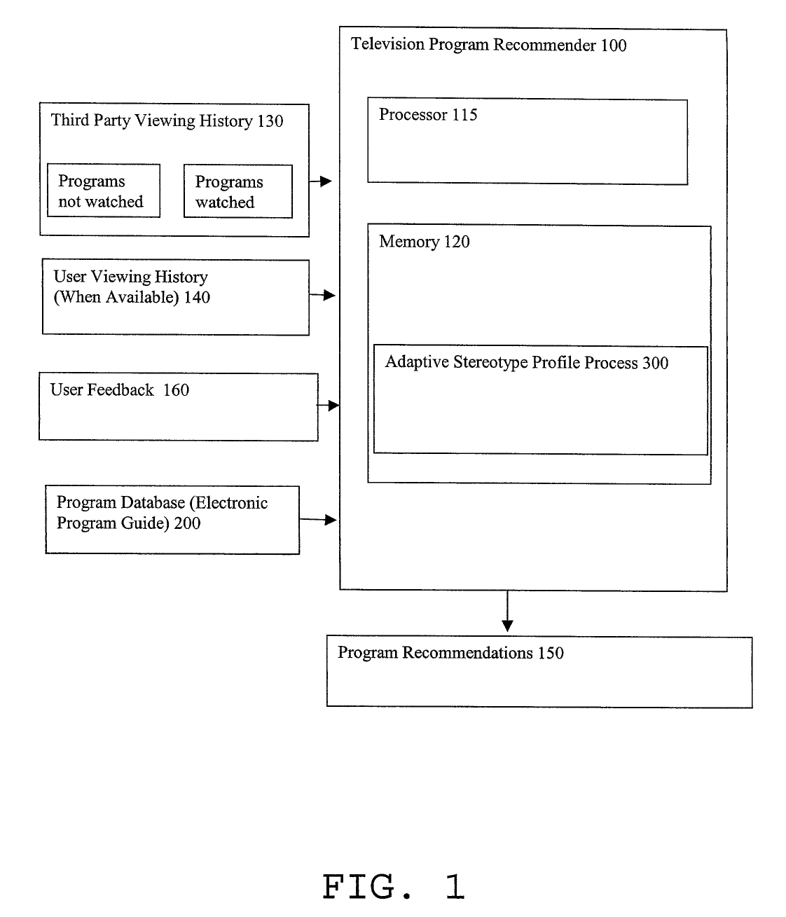

FIG. 1 illustrates a television programming recommender 100 in accordance with the present invention. As shown in FIG. 1, the exemplary television programming recommender 100 evaluates programs in a program database 200, to identify programs of interest to a particular viewer. The set of recommended programs can be presented to the viewer, for example, using a set-top terminal/television (not shown) using well-known on-screen presentation techniques. While the present invention is illustrated herein in the context of television programming recommendations, the present invention can be applied to any automatically generated recommendations that are based on an evaluation of user behavior, such as a viewing history or a purchase history. In particular, Set-top boxes, TiVo like devices (Hard-Disk Recorders, PVRs, etc.) It can also be used in any application where user profile clustering can be used. In the case of web-profiles, it is embedded in a web-browser.

The television programming recommender 100 generates television program recommendations before a viewing history 140 of the user is available, such as when a user first obtains the television programming recommender 100. As shown in FIG. 1, the television programming recommender 100 employs a viewing history 130 from one or more third parties to recommend programs of interest to a particular user. Generally, the third party viewing history 130 is based on the viewing habits of one or more sample populations having demographics, such as age, income, gender and education, which are representative of a larger population.

As shown in FIG. 1, the third party viewing history 130 is comprised of a set of programs that are watched and not watched by a given population. The set of programs that are watched is obtained by observing the programs that are actually watched by the given population. The set of programs that are not watched is obtained, for example, by randomly sampling the programs in the program database 200. In a further variation, the set of programs that are not watched is obtained in accordance with the teachings of U.S. patent application Ser. No. 09/819,286, filed Mar. 28, 2001, entitled “An Adaptive Sampling Technique for Selecting Negative Examples for Artificial Intelligence Applications,” assigned to the assignee of the present invention and incorporated by reference herein.

The television programming recommender 100 processes the third party viewing history 130 to generate stereotype profiles that reflect the typical patterns of television programs watched by representative viewers. A stereotype profile is a cluster of television programs (data points) that are similar to one another in some way. The stereotype profiles can be generated using any of a number of ways. For example, as described in U.S. patent application Ser. No. xx/xxx,xxx filed Nov. 14, 2001, entitled “Method and Apparatus for Generating a Stereotypical Profile for Recommending Items of Interest Using Item-Based Clustering,” and in U.S. patent application Ser. No. xx/xxx,xxx filed Nov. 13, 2001, entitled “Method and Apparatus for Generating a Stereotypical Profile for Recommending Items of Interest Using Feature-Based Clustering,” each incorporated herein by reference.

The television program recommender 100 may be embodied as any computing device, such as a personal computer or workstation, that contains a processor 115, such as a central processing unit (CPU), and memory 120, such as RAM and/or ROM. The television program recommender 100 may also be embodied as an application specific integrated circuit (ASIC), for example, in a set-top terminal or display (not shown). In addition, the television programming recommender 100 may be embodied as any available television program recommender, such as the Tivo™ system, commercially available from Tivo, Inc., of Sunnyvale, Calif., or the television program recommenders described in U.S. patent application Ser. No. 09/466,406, filed Dec. 17, 1999, entitled “Method and Apparatus for Recommending Television Programming Using Decision Trees,” U.S. patent application Ser. No. 09/498,271, filed Feb. 4, 2000, entitled “Bayesian TV Show Recommender,” and U.S. patent application Ser. No. 09/627,139, filed Jul. 27, 2000, entitled “Three-Way Media Recommendation Method and System,” or any combination thereof, each incorporated herein by reference.

The television programming recommender 100 includes a program database 200, and sever routines in memory 120, such as the stereotype profile process 300, as well as (not shown) a clustering routine, a mean computation routine, a distance computation routine and a cluster performance assessment routine. Generally, the program database 200, may be embodied as a well-known electronic program guide and records information for each program that is available in a given time interval. The adaptive stereotype profile process 300 (i) processes the third party viewing history 130 to generate stereotype profiles that reflect the typical patterns of television programs watched by representative viewers; (ii) generates recommendations against a so called ground truth using the selected stereotypes, computing the distance between each show in the ground truth data with the centroid of each stereotype in the stereotypical profile (The ground truth data is the set of shows for which the user has given specific information like how much he/she likes the show. For example, the user may indicate he/she loves the show ‘Seinfeld’. Loves could be translated as being between 0.85 and 1.0 or any other suitable scoring conversion scheme.); (iii) If there is disagreement between the computed recommendation and the original ground truth data (For example, if a user indicated he/she loves ‘seinfeld’ then the score should be between 0.85 and 1.00, then we know when we compute the recommendation and the score is less than 0.85, there is a disagreement.), then additional feedback is solicited from a user transforms the recommendations using user feedback 160; (iv) and then creates a meta-profile using the user feedback, which consists of the set of all weights the user has provided for the shows that he/she wants the shows to be recommended or discarded (e.g. positive/negative reinforcement); and (v) recomputes the recommendation using the meta-profile against the stereotypical profile.

In particular, in one exemplary embodiment, the clustering routine may be called by the adaptive stereotype profile process 300 to partition the third party viewing history 130 (the data set) into clusters, such that points (television programs) in one cluster are closer to the mean (centroid) of that cluster than any other cluster. The clustering routine calls the mean computation routine to compute the symbolic mean of a cluster. The distance computation routine is called by the clustering routine to evaluate the closeness of a television program to each cluster based on the distance between a given television program and the mean of a given cluster. The clustering routine then calls a clustering performance assessment routine to determine when the stopping criteria for creating clusters has been satisfied, as further described in U.S. patent application Ser. No. 10/014,189 filed Nov. 13, 2001, entitled “Method and Apparatus for Generating a stereotypical profile for recommending items of interest using feature-based clustering,” incorporated herein by reference.

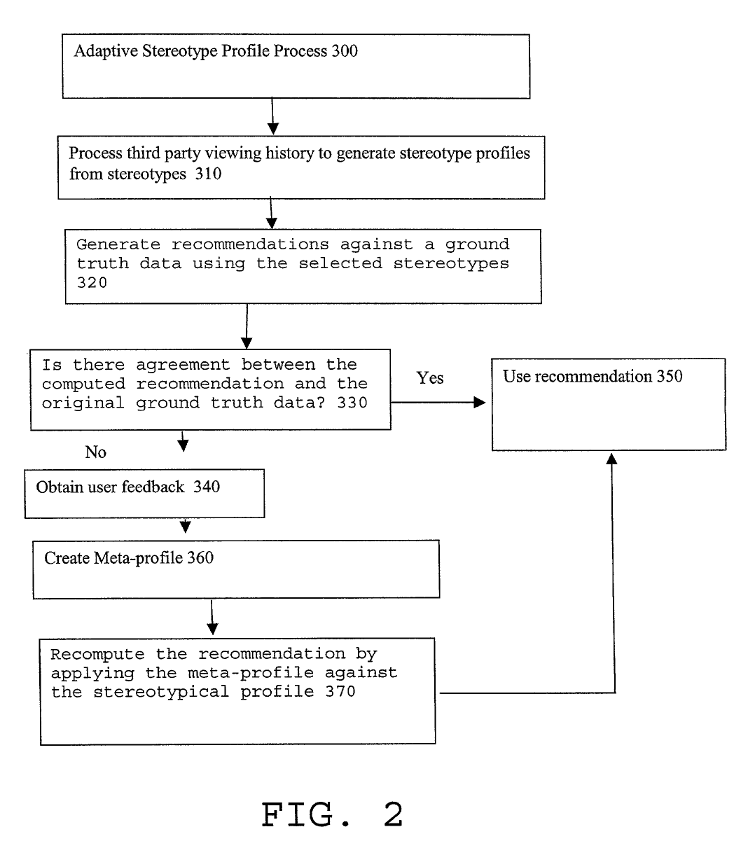

FIG. 2 is a flow chart describing an exemplary implementation of the adaptive stereotype profile process 300 incorporating features of the present invention. As previously indicated, the adaptive stereotype profile process 300, in step 310 processes the third party viewing history 130 to generate stereotype profiles from stereotypes that reflect the typical patterns of television programs watched by representative viewers. In step 320 generates recommendation against a ground truth data using the selected stereotypes. The recommendations are computed by computing the distance between each show in the ground truth data with the centroid of each stereotype in the stereotypical profile using the following equation:

$$D ( {S}_{1} - {S}_{2} ) = {\sum }_{1}^{N} δ ( {S}_{1 i} - {S}_{2 i} )$$

where S1 and S2 correspond to the two shows and N corresponds to the number of features that constitute the show record. Please note that the distance D is normalized to lie between 0 and 1.

Thereafter in steps 330-350, the computed recommendation is compared with the original ground truth data, and if there is disagreement between, then the user is prompted for additional feedback regarding the recommendation. The feedback can be obtained from the user by any conventional process. The feedback is then used to form a weight factor. As an example, if the user indicates he likes all movies of Clint Eastwood, then the overall score of shows having Clint Eastwood is increased and vice versa. Moreover, this weight factor is used at the program-level as well as at the feature-level. For example, at the whole show level or individual features that constitute the show such as, actors, genres, etc. The feedback is used to create a meta-profile, in step 360, which consists of the set of all weights the user has provided for the shows that he/she wants the shows to be recommended or discarded (e.g. positive/negative reinforcement). Lastly, in step 370, the recommendation is recomputed by applying the meta-profile against the stereotypical profile:

$$D ( {S}_{1} - {S}_{2} ) = ( 1 - W ) {\sum }_{1}^{N} δ ( {S}_{1 i} - {S}_{2 i} )$$

It is noted that the weight for the stereotypical profile is usually set to 1 since the shows in the profile are the centroid itself. Intuitively, when the user gives feedback, he/she wants the shows scores to move closer to the centroid or away from the centroid. Note that the measure given above gives a distance. Ideally, shows have a zero distance, which implies that shows are closer to the centroid. In order to get a score; it is subtracted from 1. Illustratively, if the user has given the following feedback for a particular show—don't care, likes it well and loves it which correspond to 0, 0.7 and 1 respectively. Furthermore let's us assume that the actual computed distance between the show and the stereotypical profile is 0.2. The table below shows the computed values with the equations shown above.

| Weight | Distance | Probability |
|---|---|---|
| 0 | 0.2 | 0.8 |
| 0.7 | 0.06 | 0.94 |
| 1 | 0 | 1.0 |

Note that special boundary conditions need to be established in cases when the user does not like it at all—for example if the user says (−1) then the show should not be recommended at all. In cases, when the distance exceeds 1 it has to be re-normalized so that scores could be computed.

It is to be understood that the embodiments and variations shown and described herein are merely illustrative of the principles of this invention and that various modifications may be implemented by those skilled in the art without departing from the scope and spirit of the invention.

What is claimed is:

1. A method for use in a recommender for recommending items of interest to a user, said method comprising the steps of:
generating an initial recommendations using stereotypical profiles and a ground truth data;
obtaining user feedback regarding the recommendation if the initial recommendation and ground truth data disagree; and
generating a revised recommendation using the user feedback.

2. The method of claim 1, wherein said generating an initial recommendations step includes generating stereotypes, which are used to build the stereotypical profiles.

3. The method of claim 2, wherein said generating an initial recommendations step includes computing a distance between each item in the ground truth data with the centroid of each stereotype in the stereotypical profile.

4. The method of claim 3, wherein said generating a revised recommendation includes creating a meta-profile, said meta-profile includes a set of weight factors based on the user feedback, and said meta-profile is used to generate the revised recommendation.

5. The method of claim 3, wherein said distance, D, between two values, S₁ and S₂ for a specific symbolic feature is given by:
$$D ( {S}_{1} - {S}_{2} ) = {\sum }_{1}^{N} δ ( {S}_{1 i} - {S}_{2 i} )$$
where S1 and S2 correspond to the two items and N corresponds to the number of stereotypes that constitute the item.

6. The method of claim 4, wherein said generating a revised recommendation includes computing a revised distance, D, by applying the meta-profile, W, against the stereotypical profile and is given by:
$$D ( {S}_{1} - {S}_{2} ) = ( 1 - W ) {\sum }_{1}^{N} δ ( {S}_{1 i} - {S}_{2 i} )$$
where S1 and S2 correspond to the two items and N corresponds to the number of stereotypes that constitute the item and

7. The method of claim 1, wherein said items are programs.

8. The method of claim 1, wherein said items are content.

9. The method of claim 1, wherein said items are products.

10. A system for use in a recommender for recommending items of interest to a user, comprising:
a memory for storing computer readable code; and
a processor operatively coupled to said memory, said processor configured to:
generate an initial recommendation using stereotypical profiles and a ground truth data;
solicit user feedback regarding the recommendation if the initial recommendation and ground truth data disagree; and
generate a revised recommendation using the user feedback.

11. A system for use in a recommender for recommending items of interest to a user, comprising:
means for generating an initial recommendations using stereotypical profiles and a ground truth data;
means for soliciting user feedback regarding the recommendation if the initial recommendation and ground truth data disagree; and
means for generating a revised recommendation using the user feedback.

12. An article of manufacture for use with a recommender for recommending items of interest to a user, comprising:
a computer readable medium having computer readable code means embodied thereon, said computer readable program code means comprising:
a step to generate an initial recommendation using stereotypical profiles and a ground truth data;
a step to obtain user feedback regarding the recommendation if the initial recommendation and ground truth data disagree; and
a step to generate a revised recommendation using the user feedback.
